(19) United States
(12) Patent Application Publication
(10) Pub. No.: US 2003/0134586 A1
(43) Pub. Date: Jul. 17, 2003

(54) Method and apparatus for handling animals to be slaughtered

(76) Inventors: Keld Kvorning, Auning (DK); Poul Kjeldsen, Ebeltoft (DK); Jorgen Zachariassen, Marslet (DK)

Correspondence Address: James C. Wray, Suite 300, 1493 Chain Bridge Road, McLean, VA, 22101, US

(21) Appl. No.: 10/345,306

(22) Filed: Jan. 16, 2003

(30) Foreign Application Priority Data
Jan. 16, 2002 (DK) PA 2002 00071

(51) Int. Cl. A22B 7/00; A22C 18/00; A22C 21/00

(52) U.S. Cl. 452/182

(57) ABSTRACT

A method and an apparatus are described for handling chicken (4) suspended in transport shackles (24).

The apparatus enables a safe securing of shank (88) and drumsticks (86) together with the animal when it passes through an inspection unit (76) Thus, the animal will be arranged with the knee joints (14) at the one side (84) of the transport shackle (94), while the shank (88) and the drumstick (86) are arranged at the other side (90) of the transport shackle (24).

With the apparatus and method described it is possible to keep the animal's foot (104) connected with the remaining part of the animal (4) until it has been approved by inspection.

The present invention relates to a method for handling animals to be slaughtered, especially poultry in transport shackles in an overhead conveyor where inspection of the animals is performed while they are in the conveyor.

The invention also relates to an apparatus for handling animals to be slaughtered, especially poultry in transport shackles in an overhead conveyor where inspection of the animals is performed while they are in the conveyor.

The invention may be used in connection with different animals to be slaughtered, in the form of poultry and especially in the form of chicken.

By prior art methods for handling animals to be slaughtered, especially chicken, it is desired that different parts of the animal are connected until it has passed by veterinary inspection. Besides it is known that the animal is transferred from one shackle to another in a separate conveyor which due to the veterinary inspection is moved synchronously parallel with the conveyor in which the animal is still suspended such that connected parts of the animal and the animal pass through the inspection at the same time.

In certain situations it is not desired to work with synchronous conveyors during the inspection as this does not provide the necessary security for safe removal of all parts of a rejected animal.

It is obvious that a separation of individual parts constitutes a risk that parts from an animal rejected at the veterinary inspection may pass on for further treatment in a plant. It is also obvious that it will be more secure to keep all parts connected during the inspection such that when rejected, a simultaneous rejection of all parts of the animal occurs.

It is possible to leave shank and leg attached to the animal during the handling of the animal through slaughter line, evisceration line, inspection line etc. in a treatment plant. However, in certain countries there are demands for pre-cutting the animas' legs in order to remove shank and feet in the treatment plant. When such a demand for pre-cutting exists, there will, in known systems, be a risk of feet/shank separating from the remaining part of the carcass during traditional transport in known apparatuses.

The object of the invention is to provide an improved method and an improved apparatus for handling animals to be slaughtered, especially chicken, during the process of slaughtering such that said risk of continuous treatment of parts of a rejected animal can be avoided, and where a more safe removal of all parts of a rejected animal from the apparatus is also achieved after the inspection.

According to the present invention, this is achieved with a method of the type mentioned in the introduction which is peculiar in that that the animal's legs are partially cut through/broken through in the knee joint from the back side of the legs, that the animal is suspended in a transport shackle with knee joints at one side and shank and drumstick at the other side of the shackle, where shank and feet are retained in the shackle during inspection as they are connected to the drumstick, and that the knee joint is cut after the inspection.

The apparatus according to the invention is peculiar in that before an inspection line it comprises first organs for partial cutting through/breaking through the animal's knee joints from the back side of the legs and leaving the leg's shank and drumstick connected, and that it comprises further organs for cutting the knee joint after the inspection line.

In the present invention front and back refer to the orientation of the legs in relation to the animals such that the back side is the side of the leg which is oriented at the back of the animal, and the front is the part of the leg which is oriented at the breast of the animal.

With a method and an apparatus constructed with these characteristics, it is thus possible to handle poultry and preferably chicken in such a way that the foot is connected with the rest of the carcass in a safe way until the inspection is over, even in the cases where there is a need/desire to perform a partial cut through/break through of the knee joint in the slaughter line. Thus, the transport shackles will be used to keep shank/feet connected with the remaining part of the body until the desired complete cutting of the leg is performed. Thus, it is possible to perform the transfer from one conveyor to another automatically in a way where the shank/foot is connected with the remaining part of the animal via the partially cut through knee joint. This is advantageous compared to a manual transferring from one shackle to another.

The cohesion mainly occurs by the sinews at the front of the leg remaining intact such that a specifically safe cohesion is achieved until an inspection is over. In other words, there will be no risk that the shank is separated from the carcass, and is thereby unintentionally treated further in a situation where the carcass is rejected after a veterinary inspection. It is likewise, in a simple way, with traditional technique possible to remove the whole carcass with the connected legs if it turns out that this is rejected.

In a very simple way, the method and the apparatus are suitable for use in connection with existing equipment for slaughtering animals, especially poultry, and for example the type which are produced and marketed by the applicant, and which are described in the company's product catalogue and for example of the type described in WO 93/20001. Thus, it is possible to construct the apparatus according to the invention with a basic principle as illustrated in this publication.

However, it is possible to use method and apparatus in poultry processing plants which are constructed differently, when it is ensured that the apparatus is constructed with the possibility of performing the partial cut through/break through in a unit with first cutting means arranged at a handling stage situated ahead of an inspection stage, and where there is the possibility of a complete cutting/cutting off of leg/foot or parts of the foot in a unit after the inspection stage with further cutting means for sinews and skin flaps connecting the shank with the drumstick.

As mentioned it is preferred that the cutting is performed in the animal's knee joint such that the sinews of the leg are kept intact at the front of the leg. Hereby, commonly known cutting units may be used very simply at the pre-cutting/pre-breaking, for example of the type which is used by the applicant today but which are modified by removal of one single knife in the cutting means. At the same time, the cutting through/breaking through in the knee joint enables the animals to be suspended in a U-shaped shackle after the inspection in such a way that the shanks of the legs are oriented at the same side of the shackle as the legs' drumsticks. Hereby, it becomes possible to cut the feet or parts hereof before cutting the sinews/skin flaps.

With this construction it is thus possible to cut off feet or parts hereofon the approved animal such that these parts can be gathered and treated further in preparation for use. This is especially interesting for chicken feet which are used in certain countries.

If the legs' shanks are oriented approximately 90° in relation to a largely vertical orientation of the carcass during this suspension in the U-shaped shackle, an especially efficient and simple possibility for cutting off the feet is achieved. Thus, after the cutting off, the feet will freely be able to fall down into containers for further treatment. Furthermore, the cutting means which are preferably provided in the form of rotating knives can easily be built into the plant in such a way that they can move freely in relation to the carcass which is largely vertically oriented at normal suspension in the shackles.

By the method according to the invention, the animals will be transferred from one slaughter conveyor to succeeding slaughter conveyor. Preferably this occurs when the animals are suspended in the feet in a way such that the animals are subsequently suspended in the knee joints. Thus, the animals will preferable be suspended in knee joints in a suspension conveyor and in process stages. However, during suspension it is advantageous to grip the shanks in a position close to the foot in order to achieve a safe control of the animals when these are placed in the transport shackles. This suspension in the knee joints may occur before as well as after the complete separation of the feet from the remaining part of the carcass. Thus, it is possible to handle the animals in traditionally designed plants both before and after the partial cutting through and before and after the complete cutting of the legs.

According to a special embodiment, the apparatus according to the invention is peculiar in that it comprises a transfer unit with a transfer wheel having a first set of recesses for engagement below the knee joints and a further set of recesses for gripping feet/shank, and that said further recesses are provided radially sliding. With such an embodiment it will be possible to carry the weight of the animal in the first set of recesses in the knee joints and control feet and shank which will be very movable due to the partial cut through the knee joint. If part of the sinews in the leg is intact, alternatively it will be possible to support the weight of the animal during suspension of this in the feet in a way corresponding to the one in which the animals are suspended in a slaughter line. Alternatively, a cut below the knees can hereby be established for establishing the control of the animals' legs. It is advantageous to have such a control performed as hereby an especially safe transfer from one shackle to another in the overhead conveyor's transport shackles is achieved. Here it is noted that the further recesses which are provided in a position above the recesses that grip below the knee joint are to be radially sliding in relation to the transfer unit's transfer wheel. Hereby it becomes possible to slide these recesses to a radial outermost position in order to ensure that the knee joint is pushed to a position by the one side of the shackle which is opposite the side where feet and drumsticks are placed. When the drumstick achieves an initiating introduction into the U-shaped shackle, the recesses are drawn back to a radial inner position and thereby establish the necessary space for the shank to be led down into the U-shaped shackle with the foot placed at the same side of the shackle as the drumstick.

The apparatus is preferably constructed such that the first cutting means are arranged in a slaughter line and such that the further cutting means are arranged in a unit for cutting off foot and cutting the sinew. This cutting off the foot and cutting the sinew will often occur in immediate connection, however in such a way that the foot is cut off at a stage immediately ahead of cutting the sinew.

According to a special embodiment, the apparatus is peculiar in that the unit for cutting off foot and cutting the sinew comprises guide rails that are placed next to the shackles for support of the animal in the knee joint with 90°'s orientation of the shank in relation to the carcass. By using guide rails it is possible to control and position the feet in a particularly safe way such that these are retained during cutting off the lower part of the foot when this is to be used. Hereby, an especially safe cutting off in a correct way is achieved. This may in particular be important in situations where only parts of the foot are desired to be cut off for use.

A transfer unit which is used may be intended for synchronous transfer or may be supplied with buffer possibility in the transfer unit's transfer wheel. Likewise, it is possible to use transfer units which are provided with three axles or more axles. Thus, a transfer unit will have a first axle supporting a slaughter wheel from which the animals enter from a conveyor from the slaughter line. Then there will be a centrewheel which is used to transfer the animals from the slaughter wheel to a so-called EV-wheel which is connected to a conveyor to the EV-line of the apparatus. In the centrewheel of the transfer unit the animal will usually be placed with the back side facing inwards in order to be placed correctly in relation to process lines.

In the following the invention will be explained in more detail in connection to the drawing on which:

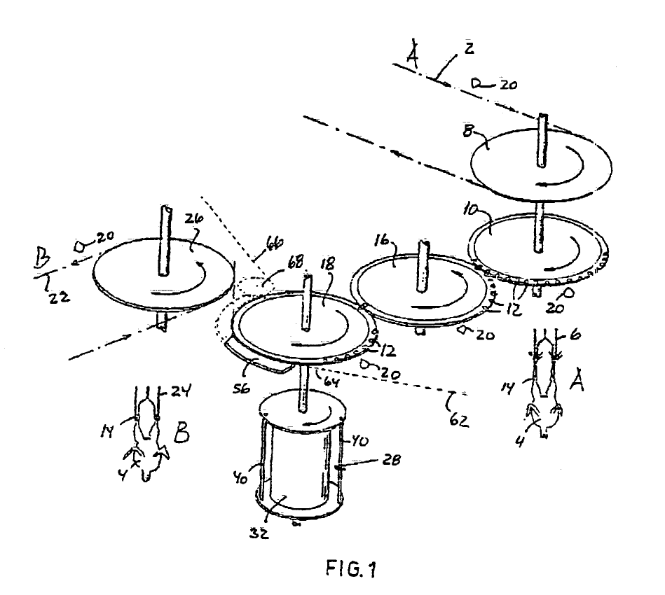

FIG. 1 shows a principle sketch of a known apparatus showing transfer of chicken from an overhead conveyor to another overhead conveyor via transfer wheels,

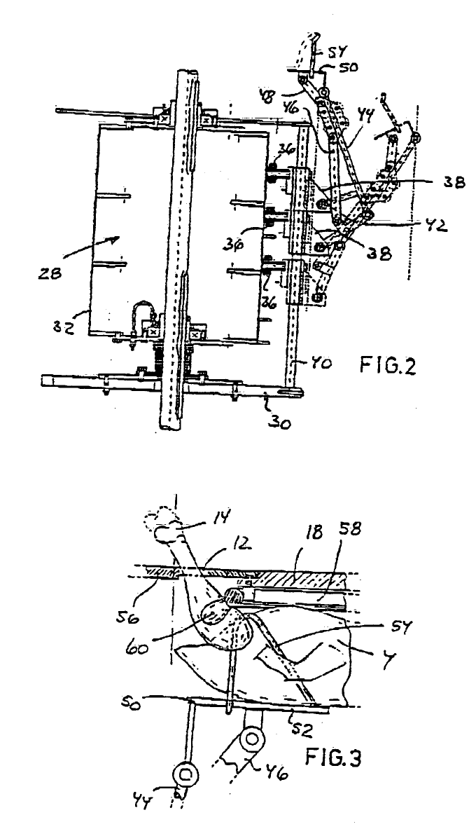

FIG. 2 shows a side view—partially sectional—of a known embodiment for a conveyor apparatus according to the invention,

FIG. 3 shows a detailed view—partially sectional—of a situation where a chicken by means of the known conveyor apparatus is lifted inwards/upwards below a transfer wheel,

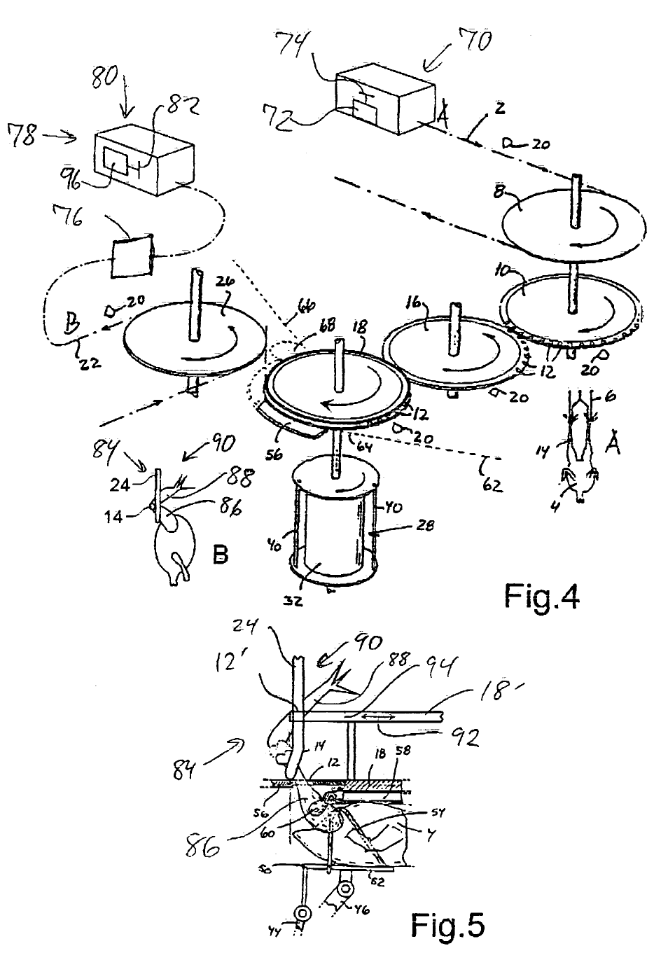

FIG. 4 shows a view corresponding to FIG. 1 of an apparatus according to the invention,

FIG. 5 shows a view corresponding to FIG. 3 of an apparatus according to the invention, and

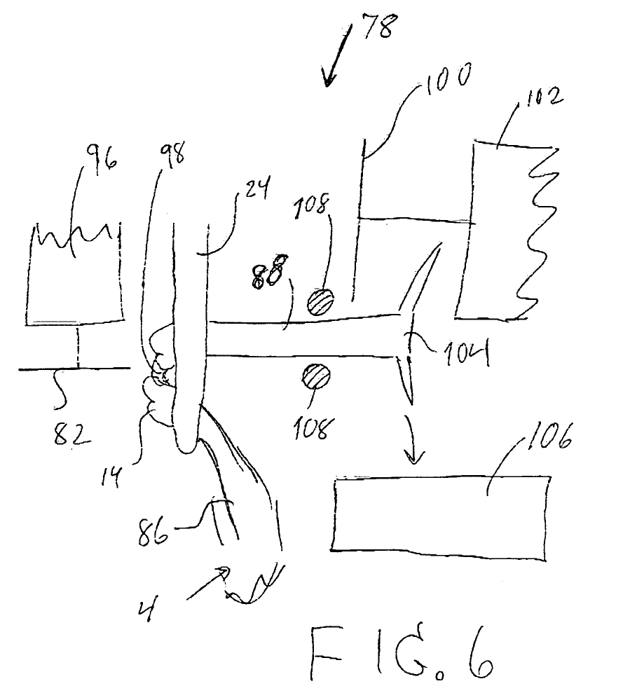

FIG. 6 shows a schematically detailed view for illustration of a situation where the shank/foot is cut off from the remaining part of the chicken.

The mentioned apparatus is in known way constructed in connection with a turning wheel of an overhead conveyor via which chicken are successively are introduced in such a way that the chicken which during the passage through the evisceration device are still suspended in legs or knees have the back side facing inwards against the axle of the turning wheel.

The apparatus shown in FIGS. 1-3 is known from WO 93/20001. This publication only discusses one single principle for an apparatus which can be modified in order to achieve the advantages of the present invention. Thus, it will be possible to use the invention in connection with apparatuses/plants that are constructed in different ways and where the animals must be transferred from one conveyor to another.

I connection with FIGS. 4 and 5 a complete explanation of the entire apparatus is not provided but merely an explanation of the points where the apparatus according to the invention differs.

The schematic sketches in FIGS. 1-3 show a slaughter line's overhead conveyor 2 where the chicken 4—as shown in view A—are suspended in the feet in shackles 6. At a distance below a horizontal turning wheel 8 is seen a transfer wheel 10 embedded on the same axle and thereby also parallel transfer wheel 10 which along the periphery is constructed with outwardly open recesses 12 in which upper end parts 14 of the chicken's lower drumsticks are fixated while the chicken 4 are still suspended in the feet of the shackles 6 of the overhead conveyor 2. The transfer wheel 10 rotates synchronously with transfer wheels 16 and 18 which concerning embodiment corresponds to the transfer wheel 10 i.e. which likewise has outwardly open recesses 12 along the periphery.

Immediately before the transfer point between the transfer wheels 10 and 16 a cutting off the chicken's 4 lower legs and feet is performed in known way by passage of a rotating knife such that lower legs and feet continue with the slaughter line's overhead conveyor 2 while the chicken 4—also in known way—suspended in the upper end parts 14 of the chicken's lower drumsticks are transferred to the remote recesses 12 of the transfer wheel 16.

In the slaughter line's overhead conveyor 2, the chicken are suspended with the breast side facing against the turning wheel 8 and the transfer wheel 10 which is shown with a signature 20 having a point which gives a convincing description of the breast side of the chicken and a curve which gives a convincing description of the back side of the chicken.

In the transfer wheel 16 the breast side of the chicken thus faces outwardly, and the transfer wheel 18 whereto the chicken are also conveyed in known way is necessary in order to make the back side of the chicken 4 face outwardly because the chicken 4 in another overhead conveyor 22 are desired to be suspended with the breast side facing outwards and with the upper end parts 14 of the lower drumsticks directly fixated in shackles 24—as shown in view B, i.e. the shackles 24 are empty at the inlet against a turning wheel 26 of overhead conveyor 22.

At a distance below the transfer wheel 18, conveyor apparatus 28 according to the invention is mounted and which has a rotating apparatus part 30 about a stationary roller part 32 which on its outer cylinder surface 34 is constructed with guide rails for control rollers 36 of sliders 38 which outside the roller part 32 are slidingly embedded on vertical sliding guides 40. By means of joint bars 42, 44, 46 and 48 the sliders 38 are slidingly connected with gripping means 50 comprising a basis plate 52 and a gripping shackle 54 projecting there from, and as shown in FIG. 2 is arranged to from the outside, i.e. from the back side of the chicken 4 which is suspended along the periphery of the transfer wheel 18, to be led against the back side of a chicken 4, grip the carcass of the chicken 4—immediately in front of the chicken's drumsticks (FIG. 3)—and to lead the chicken carcass upwards/inwards in a complex movement such that the upper end parts 14 of the chicken's drumsticks are slid outwards in the recesses 12 within a curved guide rail 56 for introduction of end parts 14 in the shackles 24 of the second overhead conveyor 22.

When the guide rail 56 stops, i.e. in the transfer zone where the end parts 14 are already slid upwards/outwards and introduced between the shackles 24, the gripping means are quickly led downwards such that the chicken 4 at weight load are allowed to be led downwards whereby the end parts 14 of the lower drumsticks are fixated in the shackles 24.

In other words, the chicken 4 are lifted while the end parts 14 of the lower drumsticks are retained in the recesses 12 within the guide rail 56, preferably from the back side inwards/upwards below the transfer wheel 18 which—as shown in FIG. 3—at the underside is provided with a ring-shaped shackle 58 that runs concentric with the recesses 12 within these and which has radially projecting guide plates 60. Opposite recesses connected in pairs, the guide plates 60 aim at gripping the outside of the chicken's drumsticks such that these are prevented from spreading when the chicken 4 by means of the gripping means 50 is lifted upwards/outwards for sliding the end parts 14 of the lower drumsticks upwards/outwards in the recess 12.

In stead of—as shown in FIG. 1—to transfer the chicken 4 from the transfer wheel 18 to the second overhead conveyor 22 opposite the end of the guide rail 56, i.e. where there is only very brief contact between transfer wheel 18 and the second overhead conveyor 22, an alternative solution may be used, i.e. where the second overhead conveyor 62—as indicated by 64—runs tangentially towards the transfer wheel 18 and as indicated by 66 does not leave the transfer wheel 18 via a smaller control wheel 68 until after an entwine zone at approximately 90° such that there is more time and better possibility of performing a precise and gentle transfer of the chicken 4 from the transfer wheel 18 to the second overhead conveyor 62, i.e. such that it is easier to compensate for possibly bent shackles 24.

This can be modified in a simple way in order to achieve the advantages of the present invention. In the following, the apparatus according to the invention which is shown in FIGS. 4 and 5 will be described based on the differences existing in the known plant, and a detailed going through of all individual parts which the apparatus according to the invention shares with the above described known apparatus will not be provided. In FIGS. 4 and 5 a unit 70 is illustrated in which means 72 are illustrated schematically for partial cutting through/breaking through the animals' knee joints. These means comprise rotating knives 74. In the embodiment shown, merely one means is illustrated, but the unit 70 may comprise more cutting means 72.

Furthermore, at the other end of conveyor 22 an inspection unit 76 is illustrated. In practice, units for opening the animal as well as evisceration of the intestines etc. will be provided before the inspection unit 76. However, such units have been omitted due to clarity. After the inspection 76, a further unit 78 is provided comprising further cutting means 80 with a rotating knife 82 for cutting/cutting off the lower leg (shank and foot).

The apparatus according to the invention moreover differs in that the animals when fixated in the shackles 24 as shown in view B in FIG. 4 are placed with the knee joints (the upper end parts of the chicken's lower drumsticks) 14 placed at the one side 84 of the shackle 24, while drumsticks 86 and shank 88 are placed at the other side 90 of the shackle 24. (also see FIG. 5). In this position, the chicken 4's carcass will be oriented largely vertical hanging from the shackle 24. The shank 88 will be oriented largely horizontally in a 90° in relation to the orientation of the animal's carcass. The animal will have this orientation when it passes through the further unit 78.

In FIG. 5 it is seen that above the transfer wheel 18 a further wheel 18′ is provided which by its outer end is provided with recesses 12′ for gripping the shank 88. As indicated by an arrow 92, in the further transfer wheel 18′ there are elements arranged for reciprocation in radial direction such that the recesses 12′ may be slid from the shown position where the knee joints 14 in a safe way are retained by the one side 84 of the shackle 24 to a radial recessed position which outer end is illustrated by dotted line 94 and which allows that the shank 88 with the foot belonging thereto can safely fall down the other side 90 of the shackle 24 in a position above the drumstick 86.

Corresponding double wheels or double segments for control of knee joints 14 and shank 88 may likewise be provided in the transfer wheels 10 and 16. In the transfer wheel 10, the animal with shanks and feet is lifted out of the slaughter line's shackles 6 with a so-called double spoon-unit.

FIG. 6 illustrates a detailed view of an embodiment of the unit 78. The rotating knife 82, driven by a motor 96, is used for cutting sinews and possible skin flaps 98 connecting the shank 88 with the drumstick 86. In a position immediately above the placement of the rotating knife 82 is provided a knife 100 which is driven by a motor 102. The knife 100 is used for cutting the shank 88 for cutting off the animal's foot 104 with en a lower part of the shank belonging thereto. Hereafter the foot 104 falls down into a container or a conveyor belt 106 for further treatment. When the knife 82 thereafter performs the cutting of sinews and skin flaps 98, the remaining part of the shank 88 will be free and can be rejected or used. In an alterative embodiment it is possible to omit the knife 100 such that the entire shank 88 hereby is freed from the upper leg/drumstick 86.

In order to position the shank 88 in a particularly safe way in relation to the knives 82 and 100 in the unit 78, this unit may be provided with guide rails 108. At the inlet side these guide rails 108 have a funnel-shaped inlet (not shown) which ensures that a shank 88 will always be introduced between the guide rails 108 irrespective of whether it is placed with the shown orientation in an approximately horizontal position.

1. Method for handling animals to be slaughtered, especially poultry in transport shackles in an overhead conveyor where inspection of the animals is performed while they are in the conveyor, characterized in that the animal's legs are partially cut through/broken through in the knee joint from the back side of the legs, where the animal is suspended in a transport shackle with knee joints on one side and shank and drumsticks at the other side of the shackle, where shank and feet are retained in the shackle during the inspection as they are connected with the drumstick, and where the knee joint is cut after the inspection.

2. Method according to claim 1, characterized in that the partial cutting through/breaking through maintains the sinews of the leg intact on the front of the leg.

3. Method according to claim 2, characterized in that the animals are suspended in the knee joints with the legs' shanks oriented to the same side of the shackle as the legs' drumsticks after the inspection, and that the feet or part of the feet are cut off before cutting the knee joint.

4. Method according to claim 3, characterized in that the legs' shanks are oriented approximately 90° in relation to a largely vertical orientation of the carcass.

5. Method according to any of the preceding claims, characterized in that the animals are transferred from one shackle to another suspended in the feet and knee joints, and that the knee joints, the shank/the feet respectively, are gripped for control of the animals during the transfer.

6. Apparatus for handling animals to be slaughtered, especially poultry in transport shackles in an overhead conveyor where inspection of the animals is performed while they are in the conveyor, characterized in that before an inspection line it comprises first means for partial cutting through/breaking through of the animal's knee joint from the back side of the legs and leaving the shank and drumsticks connected, and where it comprises further means for cutting the knee joint after the inspection line.

7. Apparatus according to claim 6, characterized in that the first cutting means are placed in a slaughter line, and that the further cutting means are placed in a unit for cutting off the foot and cutting the leg directly connected hereto.

8. Apparatus according to claim 7, characterized in that said unit comprises guide rails placed next to suspension shackles for supporting the animal in the knee joint with the shank and the feet oriented to the same side as the drumstick, and which directs the legs' shank of an angle of approximately 90° in relation to a largely vertically oriented carcass.

9. Apparatus according to claims 6, 7, or 8, characterized in that the cutting means comprise rotating knives.

10. Apparatus according to any of the claims 6-9, characterized in that it comprises a transfer unit with a transfer wheel that has a first set of recesses for engagement below the knee joints and a further set of recesses for engagement with feet/shank, and that said further recesses are provided radially sliding.
